(19) United States
(12) Patent Application Publication
(10) Pub. No.: US 2013/0068811 A1
(43) Pub. Date: Mar. 21, 2013

(54) Hand-Tool Holder That Is Mounted On Skid-Loaders

(71) Applicants: Dennis L. Matteson, Darlington, WI (US); Ryan A. Matteson, Mt. Horeb, WI (US)

(72) Inventors: Dennis L. Matteson, Darlington, WI (US); Ryan A. Matteson, Mt. Horeb, WI (US)

(21) Appl. No.: 13/622,616

(22) Filed: Sep. 19, 2012

Related U.S. Application Data
(60) Provisional application No. 61/537,220, filed on Sep. 21, 2011.

(51) Int. Cl. B60R 9/00

(52) U.S. Cl. 224/401

(57) ABSTRACT

There is currently no provision to permanently carry hand tools on a skid loader or other machinery. This device enables tools to travel with the skid loader, or other machine, and to be available at any location the skid loader, tractor, or other piece of construction equipment is at. By attaching directly to the skid loader or other machine, our device allows a shovel, or rake etc. to be held in place by clips so that these hand tools are always with the skid loader or other machine.

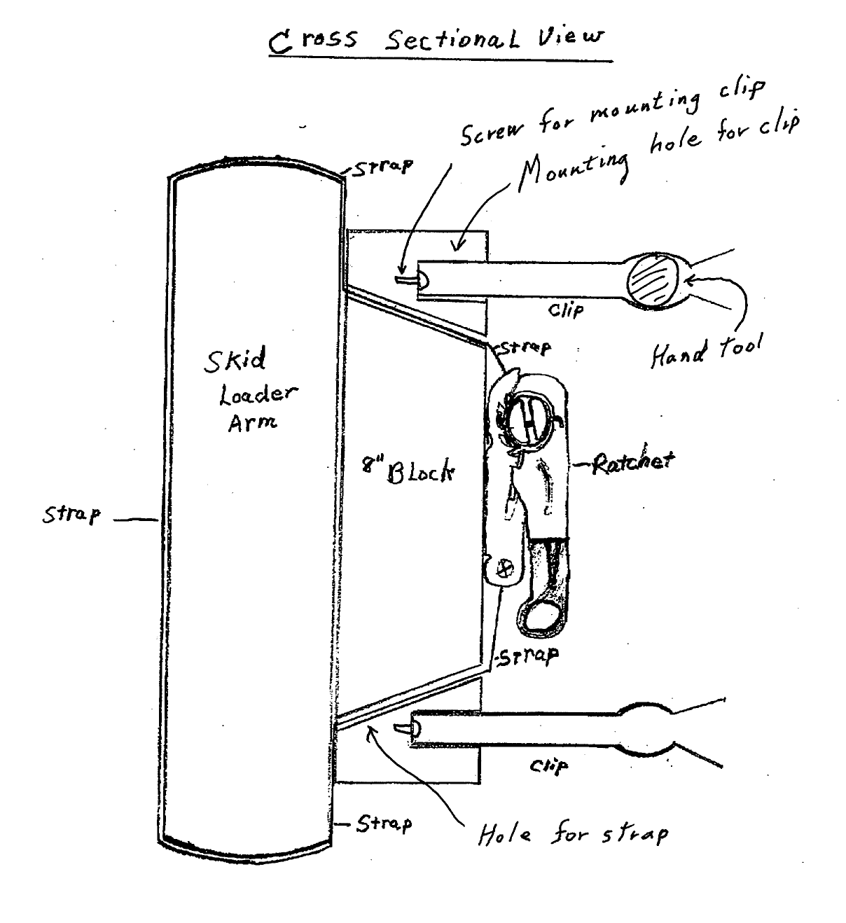

The present invention relates to a hand-tool holder that is mounted on skid-loaders.

The device is comprised of the following:
1. The base of the device is a block of UHMW plastic or other material 3″×2″×8″ or other custom dimensions, that has holes machined into it for the mounting of clips that hold the tools. There are also additional holes machined into the plastic or other material that allow mounting straps to pass through.
2. The clips are made of 9″ heat treated metal or other spring like material that
are formed into the shape of a “U” and have curves that will receive a tool handle.
3. There is a strap made of polypropylene or other UV resistant material that is 1″ to 2″ wide and 2′ to 3′ in length for attaching the mount with embedded clips, to the arms etc. of a skid loader or other machine.
4. There is a ratchet 1.5″×4″, or a similar dimension, that mounts either on the face of the plastic mount or somewhere contiguous with the strap that serves to tighten the strap and secure the mount with embedded clips to the skid loader or other machine.
All four of the elements are necessary. The block, clips, ratchet, and strap.

1. The 8″ plastic mount has a flattened back so that it will fit flush with a flat surface that it is to be mounted on. The plastic block is 2″ thick for strength, and the front is flat except for the two clip mounting holes that are machined 1″ deep. These holes could be of varying depths, but should be deep enough so that the plastic of the block supports the base of the installed clip to at least a 1″ depth. These holes are located at both the top and bottom of the block ½″ from the ends, and are 1.5″ wide and ⅝″ in height. The mount also has holes machined all the way through the block at a 20 degree angle beginning ½″ below the clip mounting hole on the front of the block, to approximately ¾″ from the top of the block on the back side. These through holes allow for the straps to pass through the block so the ratchet can tighten the block to skid loader or other machine.

2. The clips are mounted with the “U” embedded in the 1″ deep machined hole and fastened with a screw through the “U” of the clip into the plastic block. This mounts the clips at 90 degrees in relation to the plastic block and provides for a “standoff” for the tools when mounted on the skid loader or other machine.

3. The ratchet can be either situated on the face of the plastic block so that the strap when passed around an arm of the skid loader etc. and through the holes of the plastic block allows the strap to be ratcheted tight. The ratchet also may be placed outside of the block if there is room and the strap can be accessed to be started in the ratchet.

4. The strap is used for securing the whole mechanism to the skid loader or other machine. It is passed through the plastic block and around the arm or other structure of the machine it is to be fastened to, and, together with the ratchet is tightened to hold the mechanism to the machine

When the blocks are mounted in parallel pairs on a skid loader arm, the clips are in a position to accept a shovel handle etc. and to hold it securely. The blocks should be mounted around 2′ apart so the handle of the tool is gripped securely. The straps are tightened around the blocks and the arm of the skid loader by the ratchets which hold the blocks firmly. This in turn allows the blocks with the embedded clips to protrude away from the body of the machine they are mounted to, and to then receive the handles of the tools to be carried.

The plastic blocks are cut from a sheet of plastic to the 8″×2″×3″ dimensions. The clips are cut from a sheet of steel that is fifty thousandths thick to a 1.5″×9″ dimension. The plastic is then machined so that there are four holes in it to the proper dimensions. The metal is contains three bends made with two different dies. The first bend is to put an elliptical bend in first one end of the metal and then the other. The die is then changed so that the metal piece can be bent in a “U” shape with the two elliptical bends opposite each other. Holes for mounting the clips must be drilled in the base of the “U”, and holes for retainer pins may be drilled near the ends of the clips for the purpose of further securing the tool handles. The metal clips must then be heat treated to turn them into spring steel. The clips are then coated with urethane or other coatings for rust protection. Clips must then be mounted in the plastic block and a screw drilled through the clip into the block to retain the clip. The ratchet and strap are then affixed to the block.

The mounting block can be any dimension or material that suits a customer's needs. The clips also can be turned and mounted in a perpendicular direction to accommodate other applications, and can be any mounted in any number on a block. Also, the ratchet and strap may be disposed of, and the blocks mounted with screws or bolts, or even adhesives in an application.

The person using this invention would approach the skid loader that has the mechanisms attached to the loaders arm. The handle of the shovel or other tool is placed against either the bottom or top clips of both blocks. The person then gives a firm shove which locks the handle in place in the clips. Extraction of the tool is the opposite. The person would grab the shovel handle in the center between the blocks and pull firmly. This removes the tool from the clips.

These clips could be used for storage or temporary construction in the holding together of sheets of plywood, or drywall etc.

There is presently no provision for hand tool carrying on skid loaders etc.

The attached drawing shows a cross-sectional view of the hand-tool holder mounted on the arm of a skid-loader

This application claims the priority of Provisional Application No. 61/537,220, filed Sep. 21, 2011.

What is claimed is:

1. A hand-tool holder that is mounted on skid-loaders.
